(19) United States
(12) Patent Application Publication
(10) Pub. No.: US 2009/0110312 A1
(43) Pub. Date: Apr. 30, 2009

(54) Method of image compression with intelligent prediction mechanism

(76) Inventors: Chih-Ta Star Sung, Glonn (DE); Bev-Yun Kuo, Banciao City (TW)

Correspondence Address: Chih-Ta Star Sung, Rm. 308, Bld. 52, No. 195, Sec. 4, Chung Hsin Rd., Juhdong, 310, TW

(21) Appl. No.: 11/980,052

(22) Filed: Oct. 31, 2007

(51) Int. Cl. G06K 9/36; H04N 7/12

(52) U.S. Cl. 382/238; 375/240.12; 375/E07.243

(57) ABSTRACT

A method of compressing an image by referring to the correlation of previous line information results in high image quality. A register is used to save the previous line information and the derived predictive method for compressing future line of pixels. Another register is used to save the complexity of the previous line for more accurately calculating the bit rate distribution of each segment for compressing future line.

### BACKGROUND OF THE INVENTION

1. Field of Invention

The present invention relates to method of image compression, and particularly relates to image compression method by applying an intelligent prediction mechanism by referring to the recorded information of adjacent line.

2. Description of Related Art

Compression has key benefits in cost reduction of storage device and speedup in accessing the compressed data. Most popular still image compression standards including JPEG, JPEG2000 are lossy algorithms which cause data difference by quite high degree of difference between the compressed-decompressed and original image during the procedure of image compression. The data loss caused by lossy compression algorithm degrades the image quality which might not be acceptable in some applications.

There are very few lossless image compression algorithms of image data reduction. One of the most commonly adopted approach is taking differential value between adjacent pixels and applying the so called “entropy coding” or “Variable Length Coding” method which uses the shortest code to represent the most frequent happened pattern.

Lossy compression algorithms can achieve higher compression rate, for example, the JPEG has between 10 to 20 times compression ratio, at the cost of sacrificing the image quality. Sharp image quality can be achieved by the lossless compression algorithm but the compression rate is most likely lower than that of the popular lossy algorithms like JPEG or JPEG2000.

The method of this invention of image data compression is to achieve a reasonable high compression ratio compared to prior art lossless compression algorithms without sacrificing much the image quality.

### SUMMARY OF THE INVENTION

The present invention is related to a method of the image compression with intelligent prediction of compressing the current line of pixels by adopting adjacent line information. The present invention significantly increases image quality compared to other counter part high quality compression methods.

The present invention of the image compression compresses the image data segment by segment by referring to the adjacent line image information.

The present invention of the image compression compresses the image data by referring to the complexity of the adjacent line of pixels.

The present invention applies the following main new concept of taking advantage of the correlation between neighboring lines of pixels which have higher similarity and less differential value to achieve low bit rate of storing the frame of pixels:
Marking the pixels with large variance in a upper line and no compression in the current line with corresponding location, compressing others pixels referring to upper line complexity and assign bit rate of each segment accordingly.
Predicting and selecting the referencing pixel from left pixels or pixels in adjacent line.
Predicting and selecting the predicted divider without adding extra code and minimizing the code length of the Quotient and Remainder.

The present invention of the image compression records the pixel information of complexity of upper line and saves into a register for further compressing pixels of future adjacent line without inserting the upper line information to the bit stream of the current line of pixels.

According to one embodiment of present invention, a code of 1 to 4 bits are saved to represent that the prediction mode of selecting one of 3 upper pixels and 3-5 left pixels as the reference of DPCM calculation.

According to another embodiment of the present invention, a code of 1 to 8 bits are saved to represent the predicted divider of the DPCM coding which complex pixel in previous line using larger divider value and simple pattern using smaller divider.

According to an embodiment of this invention, the previous line pattern complexity is saved for predicting the bit rate distribution for future line compression.

According to another embodiment of the present invention, the simpler patter of previous line, the wider range of bit rate will be allowed for current line, and the more complex in previous line, the narrow range of bit rate will be allowed in current line in compression.

It is to be understood that both the foregoing general description and the following detailed description are by examples, and are intended to provide further explanation of the invention as claimed.

### BRIEF DESCRIPTION OF THE DRAWINGS

FIG. 1A depicts a prior art, he JPEG still image compression procedure which is a lossy algorithm.

FIG. 1B depicts another prior art of image compression: DPCM and a VLC coding.

FIG. 2 illustrates the close correlation between two adjacent lines of pixels.

FIG. 3 depicts the concept of referring to pixel of adjacent line and multiple pixels in the left.

FIG. 4 illustrates an example of a proposed procedure of predictive mode in the line by line image compression.

FIG. 5 illustrates this invention of saving an adjacent line information to a register to be reference in further line compression.

FIG. 6 illustrates the concept of applying the adjacent line pixel information to predict the bit rate distribution for each segment.

### DESCRIPTION OF THE PREFERRED EMBODIMENTS

Due to sharp quality and good immunity to the noise, and convenience in storage, the digital image has prevailingly become popular in mass applications like digital camera, digital camcorder, digital photo albums, scanner/printer/fax, image archiving and storage . . . etc.

ITU and ISO have developed and defined some image and video compression algorithms including JPEG, a still image compression standard and MPEG, the video compression standard. The JPEG image has widely applications with the cost of data loss compared to the original image.

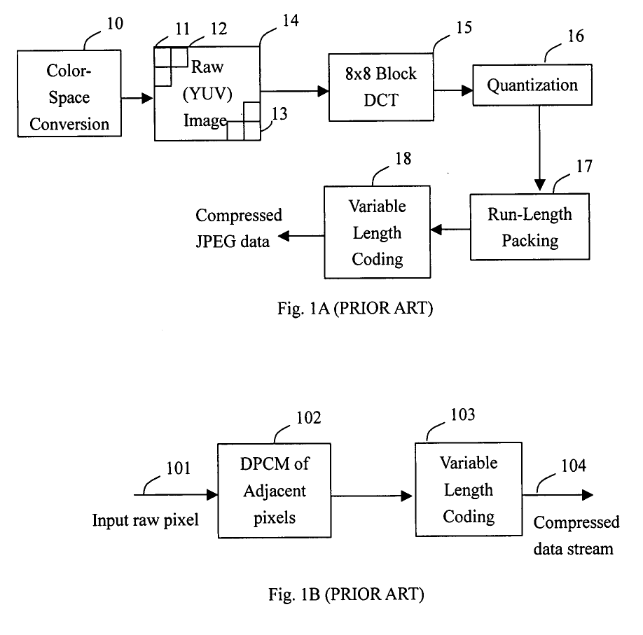

JPEG image compression as shown in FIG. 1A, a prior art of still image compression algorithm, includes some procedures in compression. The color space conversion 10 is to separate the luminance (brightness) from chrominance (color) and to take advantage of human being's vision less sensitive to chrominance than to luminance and the can reduce more chrominance element without being noticed. An image 14 is partitioned into many units of so named “Block” of 8×8 pixels to run the JPEG compression.

A color space conversion 10 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 11, 12, 13 by the following procedures:

Step1: Discrete Cosine Transform (DCT)

Step 2: Quantization

Step 3: Zig-Zag scanning

Step 4: Run-Length pair packing and

Step 5: Variable length coding (VLC).

DCT 15 converts the time domain pixel values into frequency domain. After transform, the DCT “Coefficients” with a total of 64 sub-bands of frequency represent the block image data, no long represent single pixel. The 8×8 DCT coefficients form the 2-dimension array with lower frequency accumulated in the left top corner, the farer away from the left top, the higher frequency will be. Further on, the closer to the left top, the more DC frequency which dominates the more information. The more right bottom coefficient represents the higher frequency which less important in dominance of the information. Like filtering, quantization 16 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantization step, the higher the compression and the more distortion the image will be.

After quantization, most DCT coefficient in the right bottom direction will be rounded to “0s” and only a few in the left top corner are still left non-zero which allows another step of said “Zig-Zag” scanning and Run-Length packing 17 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 18 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lo

A well known prior art of the lossless image compression method is shown in FIG. 1B which calculates the differential value 102 of the input adjacent pixels 101 and runs the variable length coding 103, the VLC coding. A VLC coding uses the shortest code to represent the most frequent happen pattern, and longer code to represent the less frequent happen pattern. Though having simplicity in realization, the disadvantage of the prior art in FIG. 1B is that it can not reach higher compression rate.

JPEG is a lossy compression algorithm, the JPEG picture with less than 5× compression rate has sharp image quality, 10× compression will have more or less noticeable quality degradation.

The JPEG compression procedures are reversible, which means the following the backward procedures, one can decompresses and recovers the JPEG image back to raw and uncompressed YUV (or further on RGB) pixels. The main disadvantage of JPEG compression algorithm is the input data are sub-sampled and the compression algorithm itself is a lossy algorithm caused by quantization step which might not be acceptable in some applications.

Very few lossless image compression algorithms have been developed due to the following two factors:
The standard JPEG Image with 10× compression rate has still acceptable good image quality in most applications.
It is tough to achieve high compression rate of the lossless compression.

This invention of the image compression overcomes disadvantages of both lossy compression algorithm like JPEG and another prior art of VLC coding of the differential values of adjacent pixel in quality and compression rate issues.

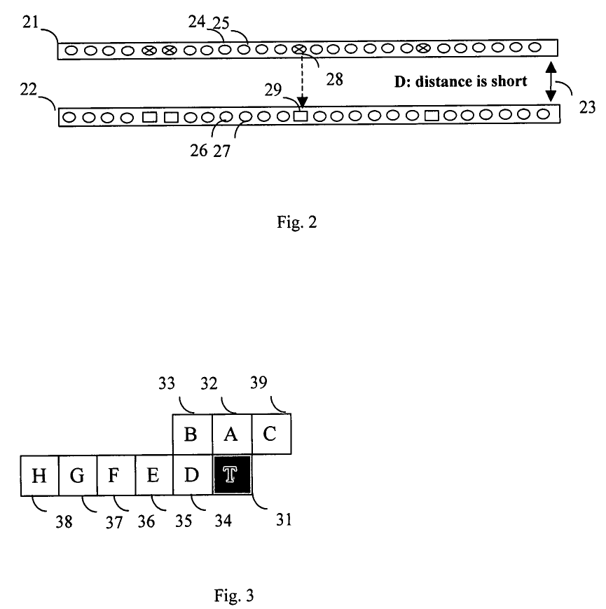

This invention adopts the basic concept of a prior art of lossless compression of taking difference of adjacent pixels for most pixels and applying a VLC coding method. One of the key inventions of this new method is applying a concept of taking advantage of close correlation 23 of line to line information 21, 22 as shown in FIG. 2. Those pixels 24, 25 in previous line having close correlation will have high probability of similar correlation in the current line 26, 27. The pixel in previous line having not close correlation 28 like an edge will have high probability of similar non-correlation in the current line 29.

A key method of this invention applies predictive means of taking differential value of adjacent pixels and selects the pixel with smallest difference to be the reference of the DPCM coding, Differential Pulse Coded Modulation. The current pixel 31 is subtracted from surrounding pixels A 32, B 33, C 39, of previous line and multiple pixels of the left D, E, F, G, H, 34, 35, 36, 37, 38. In this example, using 3 bits of data can identify the right pixel to be the reference.

Line by line, the complexity of pixels is recorded and saved into a temporary register which information is to be used as the reference of compressing future line of pixels.

The selected VLC coding method in this invention is a lossless compression to code the DPCM coded value which codes the value of “Quotient(Q)” and “Remainder(R)” as in Eq. (1) by dividing the predictive “Divider” and a marker bit to separate the Q and R. For instance, a DPCM value of 11 with the Divider=4, the Quotient will be 2 and Remainder is 3, then, the code will be 00111. For simplification in hardware implementation, the divider of this invention is shifted to be the power of “2” and used implicit way to code without coding the divider into the bit stream.

D_{—}n=Q×M+R (Y:Quotient, M:Divider, R:Remainder) (Eq.1)

For instant, a divider can always be predefined to be the average of current differential value of adjacent pixels and previous average divider as show in the equation Eq. 2, as below:

Div _{13 n}n=(Div_{—n-1}+Diff_{—n})/2 (Eq. 2)

This predictive divider has 50% weighted factor of the latest pixel information, said the Diff_{—n} and another 50% from accumulated dividers.

The pixels with high complexity of previous line are saved to a register for reference in compressing the current line. If complexity is higher than a threshold value, the DPCM value is too large and VLC code will exceed original length, said 8 bits, there is a good way to minimize it by referring to previous line and can code it as original value instead of DPCM value. Another possibility is to calculated the DPCM value and divides the DPCM value by predetermined dividers, for examples, by 2, by 4, . . . by 32, or by 64 to check which results in shortest code in coding the Quotient and Remainder and is selected to be the divider value for compressing the current line of pixels.

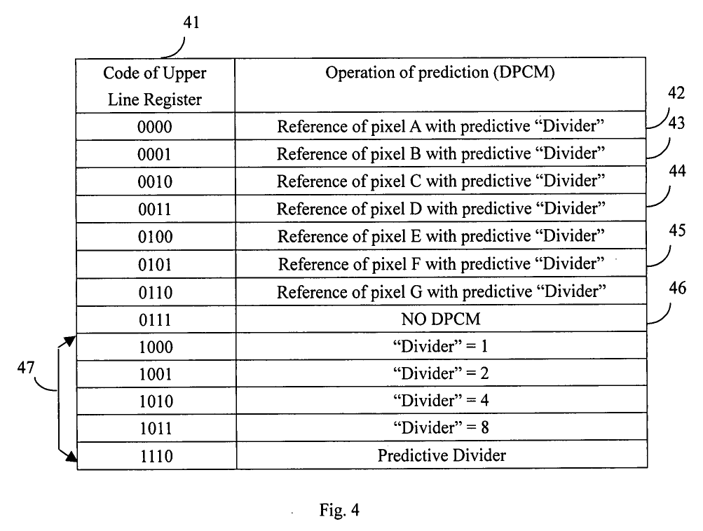

FIG. 4 summarizes the prediction mode of saving the previous line for next line compression. The predictive referencing pixel can be one of upper 2 or 3 pixels 42, 43, 44 or one of the left 4 to 10 pixels 44, 45, 46 whichever has smallest value compared to the current pixel. If all DPCM values are larger than original pixel value, a No-DPCM 48 is selected and keeps the original value. In another ay of reducing the code length is to determine which of the predetermined dividers 47 results in shortest code of representing the Quotient and Remainder.

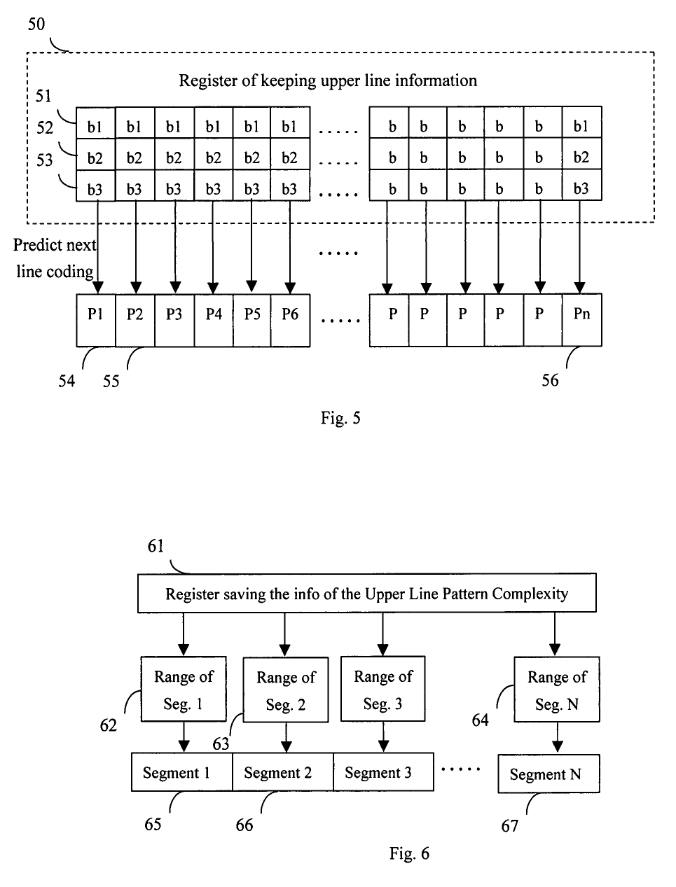

FIG. 5 depicts this invention of saving previous line pixel information, or said the compression means, as the reference of the next line compression. Each pixel of a line is compressed according to the previous line predicted compression means saved in the register, after compressing, the current line information of prediction will be saved in the register for future line. When compressing pixel by pixel, the information of complexity and optimized compression method of each pixel is saved into a register 50 with each pixel having 1 to 8 bits saved in register depending on the consideration of cost of register and efficiency of predicting model. In this example, the register of each pixel is comprised of 3 bits, b1, b2 and b3, 51, 52, 53 recording the predicted or said the optimized previous line's compression means including representation of the position of referencing pixel, the divider value and potential non-DPCM coding . . . etc. The previous line compression information of each pixel saved in the register is used as reference in compressing pixels 54, 55, 56 in current line. After compressing of each pixel, the corresponding register bit can be overwritten by the newly updated predictive information.

Besides predicting the compression algorithm and the reference of DPCM coding, this invention also uses a new way of deciding bit rate distribution by referring to the information, the pattern complexity of the adjacent line. In principle, the segment of a group of pixels will have similar pattern than the corresponding segment of adjacent line. Therefore, the previous line pixel data can be referred in deciding the bit rate of each segment in compression.

FIG. 6 illustrates the means of the more accurate bit rate distribution mechanism. The complexity information of the previous line, said for example, the PSNR (Peak Signal-Noise Ratio), under a predetermined compression ratio is saved in a register 61 and is used for determining the bit rate range 62, 63, 64 of each segment 65, 66, 67 which is also determined by referring to the corresponding segment in previous line. For example, If Segment 2 in previous line has complex pattern and can reach only 2.0 times compression of lossless quality, the same segment below will be assigned bit rate of having 2.0× time compression ratio (for 32 pixels as a segment, it has 32×8×3=768 bits, after 2× times compression the data rate is cut to 384 bits) with a tolerance of for example, 40% or said 538 bits if the previous line has simple pattern, or 10% or said only 422 bits if the previous line has complex pattern. The saving of bits of a predetermined compression ratio in each segment is accumulatively used in the future segment. Both register saving the complexity of line and each segment pattern information is comprised of flip-flop cells or SRAM cells. If SRAM cells are selected, they should be in a part of an SRAM memory array.

Since there will be correlation between adjacent frames in video frames, applying this invention of frame image compression, one can compress a video sequence with good quality. The complexity of each frame or region of a frame can be saved to a register for reference in compressing future frame and results in optimized good video quality.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of image compressing, comprising:
compressing a group of pixels line by line by firstly inputting a segment of pixels into a compression unit;
compressing each segment of current line by firstly calculating the differential value or said the DPCM value between the target pixel and the predictive reference pixel in previous line;
coding the DPCM value by dividing the value by firstly referring to the predictive divider and coding the “Quotient” and “Remainder” with a marker bit separating them; and
saving the calculated preferred or said optimized coding information of current line to a register for the reference of compressing the future line of pixels.

2. The method of claim 1, wherein at least one bit of each pixel within a line is saved to the register for the reference in compressing future line of pixels.

3. The method of claim 1, wherein at least two bits are saved to indicate which pixel of the previous line or which of at least two left pixels is selected as the reference in the DPCM value calculation for compressing the current pixel.

4. The method of claim 1, wherein a code representing the value of divider of the previous line is predetermined as the reference in the DPCM value coding for compressing the current pixel.

5. The method of claim 1, wherein a code representing “Non-DPCM coding” of the previous line is predetermined as the reference in the DPCM value coding for compressing the current pixel.

6. The method of claim 1, wherein a code representing “Predictive divider” of the previous line is predetermined if the adjacent pixel has high correlation to the current pixel.

7. The method of claim 1, wherein in coding the DPCM value, a number of continuous bits with the same polarity represent the value of Quotient followed by a marker bit with reversed pole of bit to separate the Quotient from the Remainder.

8. The method of claim 1, wherein in coding the DPCM value, a binary code with the length of bits the same with the divider is used to represent the Remainder.

9. A method of compressing an image under a predetermined compression ratio by more accurately assigning bit rate distribution to each segment, comprising:
compressing a line of pixels and saving the information of the line complexity to the first register for the reference in compressing future line;
compressing each segment of pixels and saving the complexity information of each segment to the second register for the reference in compressing each corresponding segment in future line;
calculating the range of bit rate distribution by referring to the information saved in the first register of the previous line complexity and the information saved in the second register of each segment; and
coding the DPCM value with a VLC coding algorithm by referring the predetermined bit rate distribution for each corresponding segment of pixels.

10. The method of claim 9, wherein in coding the DPCM values of a segment, the bit rate distribution is determined by adding the bit rate of the corresponding segment of previous line and the tolerance according to the first register of the line complexity of the previous line.

11. The method of claim 9, wherein the higher the complexity of the previous line, the less range of tolerance will be assigned for compressing future line of pixels.

12. The method of claim 9, wherein the lower the complexity of the previous line, the higher range of tolerance will be allowed for compressing future line of pixels.

13. The method of claim 9, wherein if not saving the complexity of the previous line to a register, when compressing current line, each segment of pixels is referred only to the addition of the bit rate of the corresponding segment of the previous line and a predetermined tolerance bit rate.

14. The method of claim 9, wherein the first register saving the complexity of the line pattern is comprised of Flip-Flop cells or SRAM cells.

15. The method of claim 9, wherein the second register saving the complexity of the segment pattern is comprised of Flip-Flop cells or SRAM cells.

16. A method of compressing a video sequence, comprising:
Compressing a frame or a region within a frame of pixels and saving the information of complexity to a temporary register for the reference in compressing future frame;
calculating the range of bit distribution by referring to the information saved in the temporary register of the previous frame or region complexity and the segment complexity information saved in the second register of each segment of current line; and
coding the DPCM value with a VLC coding method by referring the predetermined bit rate distribution for each corresponding segment of pixels.

17. The method of claim 16, wherein when compressing each frame, a frame is partitioned to be multiple lines and line by line compression procedure is applied till the end of a frame.

18. The method of claim 16, wherein when compressing each frame, a frame is partitioned to be multiple regions and region by region compression procedure is applied.
